(19) United States
(12) Patent Application Publication
(10) Pub. No.: US 2023/0249290 A1
(43) Pub. Date: Aug. 10, 2023

(54) LASER DEBURRING AND CHAMFERING METHOD AND SYSTEM

(71) Applicant: IPG (BEIJING) FIBER LASER TECHNOLOGY CO., LTD, OXFORD, MA (US)

(72) Inventor: Jackie JI, Shanghai (CN)

(73) Assignee: IPG (BEIJING) FIBER LASER TECHNOLOGY CO., LTD, OXFORD, MA (US)

(21) Appl. No.: 18/013,388

(22) PCT Filed: Jul. 7, 2020
(86) PCT No.: PCT/US20/40972

§ 371 Date: Dec. 28, 2022

(30) Foreign Application Priority Data
Jun. 29, 2020 (CN) 202010606817.9

(51) Int. Cl. B23K 26/361; B23K 26/40; B23K 26/082; B23K 26/354

(52) U.S. Cl. CPC B23K 26/361; B23K 26/40; B23K 26/082; B23K 26/354; B23K 2101/006

(57) ABSTRACT

The disclosed method for deburring and chamfering a burred sharp edge, which is defined between two transversely extending sides of workpiece, includes forming a molten pool of material on one of the sides by a laser beam which wobbles transversely to the burred edge. The wobbling amplitude of the laser beam is controlled so that the oscillating beam is prevented from being guided beyond the edge. The heat generated by the molten material is transferred to and liquefies the burrs. As the molten material cools and solidifies, it pools on the surface of the workpiece forming a raised smootcurved surface layer which chamfers the edge.

### BACKGROUND OF THE DISCLOSURE

### Field of the Disclosure

The disclosure relates to a system for laser deburring and chamfering burred sharp edges and a method of laser deburring and chamfering utilizing this system.

### Background of the Disclosure

Deburring, as illustrated in FIG. 1, is the process of smoothing the rough edges of an object that can be made of aluminum (Al), steel and other kinds of metals. A burr is thus an imperfection or protrusion that results from common manufacturing methods such as, among others, cutting, drilling, grinding, milling, shearing, welding, stamping and engraving. The burs also may be a consequence of parts' wear.

Not only do burrs make the product look bad, but they can also have a big impact on how the finished product functions, which can reduce quality and even be a safety hazard. The presence of burrs can interfere with the application of other finishing processes, such as powder coating and electroplating. Deburring is thus essential to ensure the quality and functionality of parts. Left alone, burrs can create potentially costly issues for manufacturers. It is not surprising then that deburring and edge finishing of parts may contribute as much as 30% of the part cost

There are five common classes of burrs. From classes one to two, burrs are very small and can often be removed easily. The class 3 burrs are also small, but require more extensive use of finishing tools to be removed. And burrs of classes 4 and 5 are quite large, have a strong attachment to the metal, and require a lot of effort and the use of deburring tools to remove them.

Deburring processes known to artisans are aplenty. Some of the processes can be grouped in a so-called contact deburring class and include manual deburring, electromechanical deburring, vibratory finishing, and barrel tumbling. All of these methods involve a deburring tool coming into contact with the surface to be deburred.

Manual deburring is flexible and cost-effective, but it requires a significant investment of time, making it unsuitable for finishing a large quantity of parts. Electromechanical deburring uses an electrical current combined with a salt or glycol solution to dissolve burrs. Electromechanical deburring is useful for small, precision pieces that require deburring in hard-to-reach places. Vibratory finishing involves placing the part in a rotating barrel or vibrating bowl along with a mix of liquid and abrasive components, such as ceramic, plastic, or steel finishing media. As the machine rotates, the media continuously rubs against the part in a corkscrew motion to remove sharp edges and other metal imperfections. Barrel tumbling includes placing one or more workpieces in a tumbling barrel which rotates at high speed to brush the pieces together and achieve the desired finish. In general, the contact deburring technique is known to have a few problems including a large consumable cost due to extensive wear and tear of contacting tools, and difficulties associated with complex profiles particularly those with hidden corners.

Practically, all of the above contact processes can be robotized. While the problems facing traditional not automated in-contact processes remain, robotization adds the structural and functional complexity since a number of mechanical and electronic components are sharply increased. Indeed, the process path and mechanical motion of a robotic system must be programmed and controlled very accurately since a deburring tool must be programmed to touch a workpiece, such as a wheel hub corner, without interference. Otherwise such a robotic system would have serious mechanical interference problems that may lead to the tool's crash. Furthermore, in order to protect motion axes, the cooperation force analysis system also must be integrated into the entire assembly which entails additional complexity and maintenance.

Still another group of deburring processes may be grouped together based on their non-contact nature, such as various electrochemical methods. The latter however may need post processing to remove a variety of residuals.

Another example of the non-contact deburring process—laser deburring—is the subject matter of this disclosure. All the advantages of well-developed laser technology can be utilized for laser deburring, as it is essentially an application of laser treatment. Since laser machining is a tool-free non-contact process, it can provide a very flexible machining operation as long as the thermal properties and sufficient process control of the material to be laser treated are adequate.

Laser processing is thus free from at least some of the discussed-above disadvantages of the contact process. Clearly, utilization of this technique results in very few or no consumables. During laser processing, the laser beam path can be flexibly adjusted to provide the desired chamfer. Compared to systems implementing some of the above-disclosed traditional mechanical methods, a laser-based deburring system is easily operated due to a relatively simple structure.

One of the known laser deburring is disclosed in RU2695092 (C1) teaching a method for cutting a dross of stamped forgings from titanium alloys. The disclosed method includes cutting a workpiece by a continuous wave (CW) ytterbium (Yb) fiber laser at power of 15-50 kW accompanied with a process gas flow rate is 60-90 n/h at a 20-30 bar pressure. The cutting speed is maintained at 600-1,200 mm/min, and the process gas includes argon and/or nitrogen. The method further provides trimming the cut workpiece parts which is carried out at a thickness dross up to 55 mm. However, the thus treated parts have sharp edges which are unacceptable in a variety of industrial applications.

FIG. 2 illustrates one of the known laser-based deburring systems disclosed in RU2543222 teaching the method of processing a glass edge 2 which is defined between two orthogonal faces 3 and 4. As a consequence, both orthogonal faces are annealed. The laser treatment of both faces requires that a laser beam 1 be incident on glass edge 2 at an angle φ relative to the plane of face 3. However, this requirement may have two detrimental consequences. First, it may be unacceptable for laser treatment of sharp burred metal edges since metal burrs tend to reflect laser radiation and impede melting of the irradiated metal. Second, this requirement necessitates a specifically configured working environment that may not be readily available.

The U.S. Pat. No. 10,442,719 discloses a method of chamfering the edge of various parts by utilizing a continuous wave (CW) CO₂ laser in combination with a ps pulsed laser. CW lasers capable of achieving melt depths up to 100 μm are a good choice for rougher surfaces, such as those formed by cutting, milling or erosion machining. In contrast, a pulsed laser with ps pulse durations and a melt depth of several micrometers is a popular choice for machining surfaces with low roughness. The efficiency of the pulsed laser, used for dealing with burrs, is however questionable. Also, this reference appears to teach focusing a laser beam on the edge with all the disadvantages of such technique as discussed immediately above.

A need therefore exists for a laser deburring process overcoming the above-disclosed disadvantages of the known prior art.

Another need exists for a laser deburring system implementing the inventive process.

### SUMMARY OF THE DISCLOSURE

The inventive concept utilizes a wobbling laser beam focused on only one of two workpiece sides defining therebetween a sharp burred edge of the workpiece. The wobbling laser beam initially melts the material within a radiation affected zone (RAZ). As the melted material cools down, it forms a curved smooth chamfered edge.

In accordance with one aspect of the disclosure, the inventive laser deburring process involves focusing a high energy wobbling laser beam on the one side of the workpiece, thereby melting the material within the RAZ which either includes or terminates close to the sharp jugged edge depending on the specified chamfer width. The material within the RAZ is liquefied forming a molten pool. The heat generated by the liquefied material is transferred to the edge so that the burrs are melted away. The liquefied material practically instantaneously cools down and solidifies forming a curved surface layer chamfering the edge along its entire length as the laser beam continuously travels along the edge.

In accordance with one feature of the method of the above-disclosed aspect, the laser beam wobbles in a plane transverse to the direction of the beam's displacement along the sharp edge. The wobbling amplitude is determined and controlled so as to provide the RAZ with the desired width and to prevent the propagation of the laser beam beyond the edge. In other words, the wobbling amplitude is selected so that the RAZ is located either next to the edge, i.e., borders the edge, or includes it. However, the laser beam is never guided beyond the edge.

Another feature of the method according to the one aspect includes controlling the speed of the laser beam displacement along the edge and the wobbling amplitude and frequency. These and other parameters may controllably vary depending on the material to be laser treated, edge contour, RAZ's width and other local requirements.

A further aspect of the disclosure relates to a laser deburring system carrying out the inventive method. In accordance with this aspect, the inventive system is modular. The modules include a high power laser source, wobbling laser head and multi-axis robot respectively. The laser head is configured with beam guiding and focusing optics configured to focus and wobble the beam on the surface of the workpiece within the RAZ.

The inventive system is automated and thus has a computer executing a software for controlling and adjusting numerous parameters of the system modules. While these modules each may have a dedicated computer, preferably only one on-board computer governs the entire system.

As one of ordinary skill readily recognizes, the disclosed method can be carried out only by the inventive laser system. The features of both aspects are interchangeable and can be utilized in any possible combination with one another.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates the deburring concept.

FIG. 2 illustrates one of the known laser deburring methods.

FIGS. 3A-3C illustrate the inventive process.

FIG. 4 is a diagrammatic view of the inventive laser deburring system configured to carry out the process of FIGS. 3A-3C.

FIGS. 5A-5C illustrate respective laser source, laser head and robot components of the system of FIG. 4.

FIGS. 6A-6B illustrates an exemplary Al alloy wheel hub before and after it is treated by the inventive system of FIG. 3.

FIGS. 7A-7B illustrate a portion of the wheel hub of FIGS. 6A and 6B before and after laser treatment in accordance with the inventive process in greater detail.

FIG. 8A-8B illustrate differently dimensioned chamfered edges.

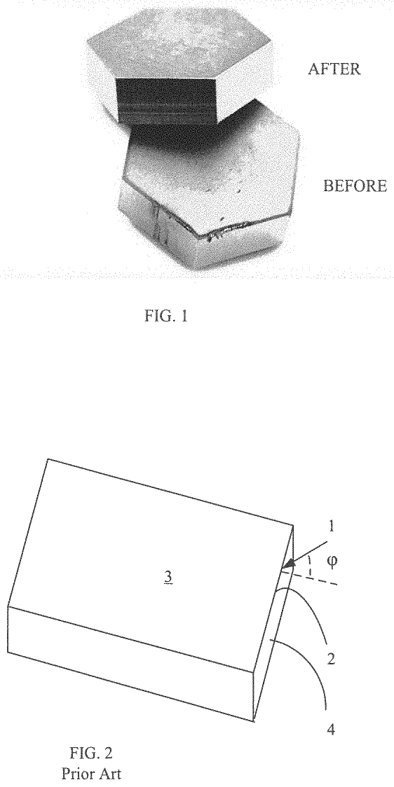

### SPECIFIC DESCRIPTION

Aspects of the present disclosure include a method of laser deburring and a system carrying out the disclosed method. The inventive method and system overcome or otherwise resolve problems faced by the known deburring techniques and devices. While the inventive concept is disclosed in the following description based on metal workpieces, such as Al alloy wheel hubs, other metals such as stainless steel, titanium, etc., can be effectively treated in accordance with the disclosed method and system with no or minimal structural modifications obvious to one of ordinary skill in the metallurgical and laser arts. Similarly, plastic- or glass-made workpieces can be deburred using the disclosed method and system subject to superficial alterations, if at all. Furthermore, the methods used to produce the workpieces to be later treated by the inventive method and system can include, without limitation, cutting, drilling, grinding, milling, shearing, welding, stamping, engraving, casting and others.

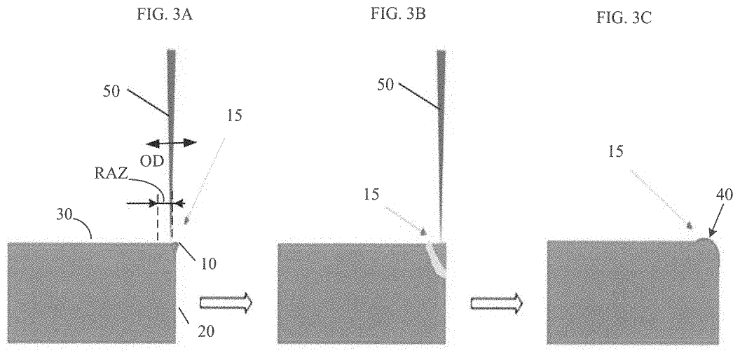

FIGS. 3A-3C illustrate sequential steps of the inventive process for deburring and chamfering the edge of a workpiece 25. The workpiece 25 is not limited to any particular shape and may have innumerous regular and irregular geometrical shapes with a limitless variety of different edge contours. Regardless of any concrete shape of the workpiece, multiple workpiece sides, for example sides 20 and 30 adjoin one another along an edge 15. The edge 15 has unwanted protrusions or burrs 10 which are to be removed by utilizing the inventive method. The latter is carried out by a laser-based system generating a laser beam 50 in a manner disclosed below.

Turning specifically to FIG. 3A, the initial step of the inventive process includes irradiating side 30 by laser beam 50. As will be explained below, beam 50 is focused on the surface of side 30 and wobbles in a direction, which is indicated by a double-head arrow OD, transverse to a direction in which laser beam 50 is guided along edge 15. As beam 15 wobbles, it forms a molten pool of material within a RAZ having the width which may be slightly greater than the beam's wobbling amplitude. The heat generated by absorption of laser radiation is transferred to burrs 10 which are melted away. The wobbling amplitude is selected and controlled such that beam 50 is not guided in the OD direction beyond burrs 10 formed on edge 15. In other words, side 20 of workpiece 25 is not directly irradiated.

As shown in FIG. 3B, as laser radiation is absorbed by the material within the RAZ, the material is rapidly heated to the molten pool which is realized by the controlled laser beam parameters, such as a laser beam power, wobbling amplitude and wobbling frequency. As the material melts within the molten pool, the heat is transferred to burrs 10 which melt away. Typically, with the chamfer width specified, generally the wobbling amplitude corresponding to the RAZ is selected to be at most slightly greater than the chamfer width (Wch). Preferably, however, the wobbling amplitude is ½ the specified Wch. Based on the foregoing, the wobbling amplitude may vary within a 0.5-1.5 Wch range provided, of course, that the beam is not incident on one of the sides defining the edge. The wobble frequency depends on the laser source power and process speed.

FIG. 3C illustrates the step in which the molten material rapidly cools and solidifies. As it happens, the material is pooling due to surface tension of the melted area and balls up on the surface of the substrate. As a result, a slightly raised smooth curved layer 40 of the solidified material chamfers edge 15 along its entire length as laser beam 50 is continuously guided along the edge in a direction perpendicular to the oscillation direction OD during the inventive process.

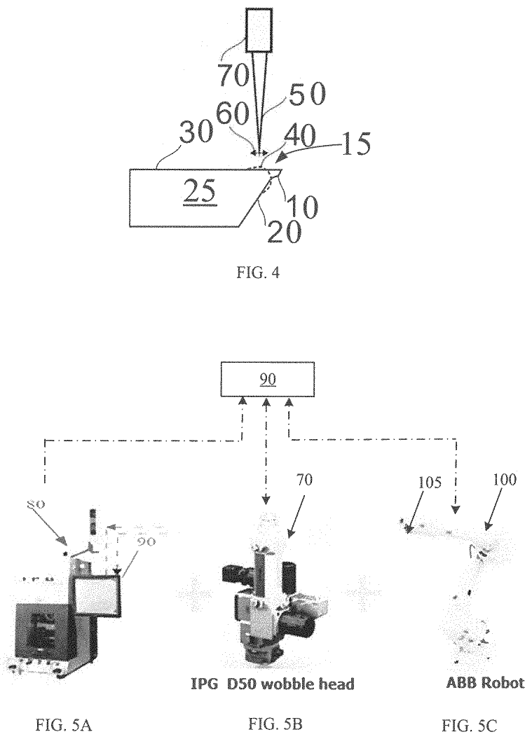

FIG. 4 diagrammatically illustrates the operating principle of the inventive system configured to carry out the above-disclosed method for deburring edges 15 of workpiece 25. The system is configured with a laser head 70 focusing laser beam 50 on the surface of, for example, top side 30 of workpiece 25. The side 30 and side 20 of workpiece 25 may be orthogonal to one another or extend at an angle therebetween which is different from the right one. Regardless of this angle, sides 20 and 30 are adjoined to define elongated edge 15 which, as a result of the workpiece manufacturing method, may be excessively sharp and/or formed with burrs 10 along its length. The laser head 70 is positioned to direct laser beam 50 not on edge 15, as taught by the discussed-above prior an, but on the RAZ of side 30 which may terminate close to or include edge 15. The incidence angle of beam 50 is shown to be substantially equal to 90° relative to the plane of side 30. However, this angle may slightly deviate from 90° which, although not altering the essential configuration of the inventive system, may affect the efficiency of the inventive method.

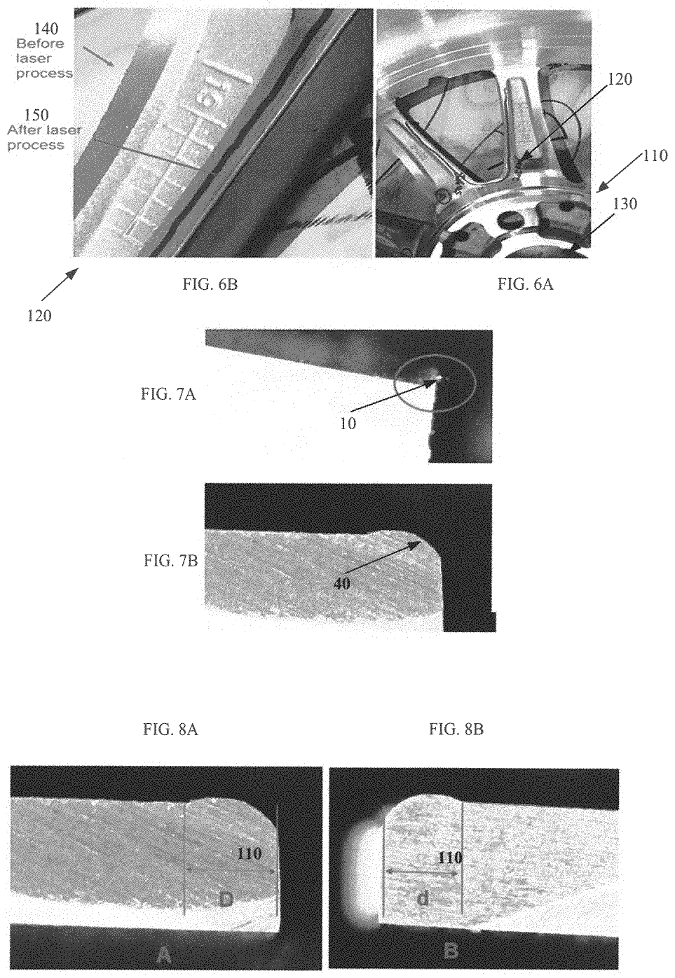

FIGS. 5A-5C illustrate respective essential components of the inventive system. Referring specifically to FIG. 5A, a laser source 80 is preferably a high power CW Yb fiber laser configured to generate laser beam 5) in a W-kW power range. The power controllably varies depending on the material of workpiece 25, its thickness and burr size and can be as low as 100 W. The upper power limit is restricted only by the beam product parameter (BPP). For example, if a single mode (SM) beam is required, the power can be as low as 100 W and as high as 5 kW, 20 kW or, if necessary, greater powers with a slightly higher BPP. For example, an Al alloy wheel hob 110 of FIGS. 6A and 6B), was experimented on by the inventive system having SM fiber laser 80 with output power between 2 and 6 kW. If the quality of light is not critical, CW multimode lasers can generate substantially higher outputs with a relatively good BPP.

The laser source 80 may also operate with a different degree of efficiency in a continuous wave (CW), quasi-continuous wave (QCW) or pulsed regimes characterized by an average pulse power within the same power range as CW lasers. Even the wavelength may vary if any given material is known to be more effectively treated at wavelengths outside a 1 μm wavelength range. Also, laser source 80 may include all configurations of solid state lasers and CO₂ laser.

The laser source 80 is often provided with an on board computer 90 preferably, but not necessarily, controlling the parameters of all essential system components—laser source 80, laser head 70 and robot 100—as shown in dash lines in FIGS. 5A-5C. Alternatively, each of the essential components may have its own dedicated computer. The computer's memory may contain a variety of laser source-related, laser head-related and robot-related parameters. For example, laser source 80 is characterized by a beam power, duty cycle and others. The laser- and robot-related parameters include a beam oscillation amplitude and frequency, focal distance, laser head's velocity and trajectory of displacement along edge 15 and others. Having multiple control feedback loops, all parameters may be adjusted in real time depending on the edge geometry, material to be laser treated and desired dimensions of the RAZ.

Referring to FIG. 5B, laser head 70 is assembled with beam guiding and focusing optics not shown but disclosed in detail in WO/2016/205805, the contents of which are incorporated by reference in its entirety. This reference teaches wobble laser head 70 with two galvanometers or other actuators configured to angularly displace respective mirrors relative to one another. The mirrors form beam 50 wobbling in a plane lateral to the direction of the beam's displacement along edge 15. The wobbling amplitude is selected so that wobbling beam 50 is not guided beyond edge 15. In other words, side 20 of workpiece 25 is not directly irradiated.

The laser head 70 was used in experiments involving Al alloy wheel hub 110 (FIG. 6A) and configured to provide oscillation of laser beam 50. In accordance with one set of parameters, hub 110 was processed with a 2.5-3 KW multimode (MM) fiber laser operating in a continuous wave (CW) regime, wobbling frequency varying between 100 Hz-2 kHz, wobbling amplitude varying between 0.1˜5 mm and 60˜100 mm/s process speed. Another set of parameters included a 3˜6 KW CW MM laser, wobble frequency 100˜2000 Hz, 0.5˜5 mm amplitude, about 100˜300 mm/s process speed. Generally, the higher the power of the source, the higher the processing speed.

FIG. 5C illustrates exemplary multi-axis robot 100. It includes an arm 105 supporting and guiding laser head 70. The configuration of robot 100, like configurations of laser source 80 and laser head 70, may have a limitless variety of different designs provided that the required functions of each system component are performed. The robotic arm 105 allows deburring and chamfering edges extending in various different planes and having a variety of edge contours. For instance, robot 100, partaking in the experiment with wheel hub 110, was configured to displace laser head 70 along edge 15 at the velocity varying in a 100+300 mm/sec range. The velocity is controlled to provide simultaneous oscillatory and linear/rotary motions of laser head 70. The linear and/or rotary motion depends on the edge geometry which may include straight, curved and more complex profiles.

Turning now to FIGS. 6A and 6B, as mentioned above, the inventive method and system were tested on AL alloy wheel hub 110 of FIG. 6A having a plurality of spokes 120 which extend radially from a hub 130. As known, the wheel is initially lathed. After lathing, many edges, for example rear edges of respective spokes 120, are sharp and jagged. Traditional automated deburring methods are rather ineffective in treating at least some areas of the wheel including, for example, the corner between spoke 120 and hub 130.

As shown in FIG. 6B, the disclosed process has been proven to overcome certain difficulties associated with the traditional methods. Particularly, spoke 120 is shown to have one of the edges—edge 140 that has not been chamfered in accordance with the inventive method. In contrast, the other edge 150 has been laser treated. As can be seen, treated edge 150 is chamfered and burr-free. The experiments have shown only local heating of the sharp corner of wheel hub 110, which means that the overall temperature of the wheel has risen to less than 60˜100° C.—the temperature range required by customers. In fact, the overall temperature of the entire wheel hub 110 has been risen at less than 10° C. which meets the processing requirements and does not affect the structure strength and other properties of the wheel hub.

FIGS. 7A and 7B illustrate respective workpiece samples A and B with enlarged images of edge 150 with FIG. 7A showing the edge with burr 10 before the inventive process takes place. FIG. 7B illustrates the burr-free curved layer 40 of the solidified material smoothing the sharpness of the edge after the inventive laser treatment.

FIGS. 8A and 8B illustrate respective samples A and B each having a burr-free smooth edge laser treated in accordance with the inventive method. The only difference between these samples is that sample A has a 2.5 mm wide RAZ, whereas sample B is formed with a 2 mm wide RAZ.

Having thus described several aspects of at least one example, it is to be appreciated that various alterations, modifications, and improvements will readily occur to those skilled in the art. All of the disclosed features of each of the aspects can be combined together or used in any desirable combination. The operational parameters disclosed above are exemplary and can be controllably changed if necessary without comprising the inventive scope of this disclosure. Accordingly, the foregoing description and drawings are by way of example only.

1. A method of laser deburring and chamfering a burred edge defined between two transversely extending sides of a workpiece, comprising the steps of:
(a) wobbling a laser beam incident on a surface of one of the sides, thereby creating a molten pool of material of the workpiece within a radiation affected zone (RAZ), the molten pool generating heat transferred to and liquefying burrs on the burred edge, wherein the laser beam is not guided beyond the burred edge; and
(b) displacing the laser beam parallel the burred edge and transversely to the laser beam oscillation, wherein the molten pool of material within the RAZ cools down and solidifies so that a smooth, curved surface layer chamfering the edge is formed.

2. The method of claim 1, wherein step (a) includes focusing the wobbling laser beam on a surface of the one side.

3. The method of one of the above claims further comprising controlling a wobbling amplitude of the laser beam so that that the RAZ includes the or borders the burred edge.

4. The method of one of the above claims further comprising controlling a wobbling frequency of the laser beam wobbling and laser beam power.

5. The method of one of the above claims further comprising controlling a velocity of the beam displacement along the burred edge, thereby continuously displacing the wobbling laser beam without interrupting the laser beam oscillation.

6. The method of claim 1, wherein the material of the workpiece is metal, metal alloys.

7. The method of claim 1, wherein the workpiece is an Al alloy wheel hub is provided with a plurality of spokes which radially extend from the hub and have respective burred edges, the burred edges each being deburred and chamfered by the wobbling beam which is displaced at the velocity within a 100+300 mm/sec range and oscillates at the wobbling amplitude varying in a 0.5+5 MM diapason at the wobbling frequency from 200 Hz to 2 kHz, and has an average power between 2 and 20 kW.

8. The method of claim 3, wherein the wobbling amplitude is controlled within a 0.5-1.5 Wch, wherein Wch is a specified chamfer width.

9. A system for deburring and chamfering a burred sharp edge of a workpiece having at least two sides which adjoin one another along the burred sharp edge, the system comprising:
a laser head configured to provide a laser beam with wobble and focus the wobbling laser beam on a surface of one of the sides so as to irradiate a RAZ, the oscillating laser beam having a light energy absorbed by material of the workpiece within the RAZ so as to form a molten pool of material, the molten pool generating heat transferred to and liquefying burrs on the edge; and
an actuator supporting and guiding the laser head along the burred edge in a direction transverse to a plane of the wobble, the melted material cooling and solidifying in the RAZ so that a curved smooth surface layer chamfering the edge is formed, wherein a wobbling amplitude is controlled to stop the wobbling laser beam from being guided beyond the edge.

10. The system of claim 9 further comprising a solid state or CO₂ laser source generating the beam incident on the laser head, and operating in a continuous way (QW), quasi QW or pulsed regime.

11. The system of claim 9, wherein the wobbling amplitude is controlled so that the RAZ is located adjacent to or includes the burred edge.

12. The system of claim 11, wherein the laser beam is generated with an average beam power varying between 100 W and 20 kW.

13. The system of claim 9, wherein the laser head is configured with beam guiding and focusing optics, the beam guiding optics being operative to provide the laser beam with the wobbling amplitude varying in a 0.1+5 MM diapason at a wobbling frequency from 100 Hz to 2 KHz.

14. The system of claim 9 further comprising
at least one computer executing software for controlling the wobbling amplitude, wobbling frequency, beam power and trajectory of laser head displacement along the burred edge, and
a multi-axis robotic arm supporting and guiding the laser head along the burred edge at a controlled velocity.

15. The system of claim 14, wherein the burred edge is straight or curved or a combination of straight and curved edge contours.

16. The system of claim 9, wherein the workpiece is an Al alloy wheel hub treated by irradiated by the wobbling laser beam generated by a CW fiber laser.
